(19) United States
(12) Patent Application Publication
(10) Pub. No.: US 2003/0227119 A1
(43) Pub. Date: Dec. 11, 2003

(54) Cutting board

(76) Inventor: Mark Jackson, Pontiac, MI (US)

Correspondence Address: Paul K. Tomita, 2404 Spaulding Ave., Berkeley, CA, 94703, US

(21) Appl. No.: 10/162,343

(22) Filed: Jun. 5, 2002

(51) Int. Cl. A01J 15/14

(52) U.S. Cl. 269/25; 99/467

(57) ABSTRACT

A cutting board has a cutting surface with a cut away section at one edge and support members which elevate the cutting surface from a working surface. The cutting surface is elevated so that an open space exists under the cut away section which is large enough to place a plate, container or a cooking device. The open space also allows a person to easily place a hand under the cutting surface to lift the cutting board and transfer food items to a container or cooking device. The cut away section has a curvature which is similar to the outer diameter of the plate, container or cooking device. Food items are cut on the cutting board and pushed over the curved edge onto the plate, container or cooking device.

### BACKGROUND

Cutting boards are well known devices which provide a surface upon which items are be placed while being cut with a knife or any other cutting device. The cutting board also protects the surface of the underlying support such as a table or countertop. After the food items are cut on the cutting board, the cut food items are typically transferred to another container or cooking apparatus such as a pot, pan, bowl or plate. In order to transfer the cut items, the cutting board is lifted and placed over the container or cooking apparatus into which the cut food is to be transferred. Alternatively, the cut food may be slid onto a knife blade by hand and carried on the knife to the plate, container or cooking apparatus.

Most containers, pots, pans, bowls and plates are circular in shape. In contrast, conventional cutting boards are rectangular in shape and have straight edges. In order to transfer cut food items from the rectangular cutting board to a circular space, the cutting board must be picked up with one hand and an edge of the cutting board must be placed over a wide cross section of the circular space. The other hand may hold the knife which is used to push all of the cut food into the wide cross section of the circular space. As the knife pushes cut food items over the surface of the cutting board, the food items tend to disperse across the length of the blade. More specifically, the food items may be chopped in a small group at the center of the cutting board and when a straight edge is used to slide the food items, the small group disperses into a wider group. The dispersion of the cut food may be proportional to the distance that the food slides over the board. Because the food is dispersed across the blade, the edge of the cutting board needs to be placed over a wide section of the plate, container or cooking device so that all of the food items are properly transferred. If the board is not placed over a wide area, some of the food items dispersed to the edges of the group may not fall into the circular plate, container or cooking device.

### SUMMARY OF THE INVENTION

The inventive cutting board has a cutting surface which is elevated and has a cut away section which simplifies the transfer of cut food items to a circular plate, container or cooking device. The cutting board is elevated from a working surface by a support member or support members which are mounted under the cutting surface. The support members may be positioned under the cutting surface such that an open space exists under the cut away section of the cutting surface. The space under the cut away section may be large enough for a plate, container or cooking device to be placed and food items chopped on the cutting board and slid over the cutaway section are easily transferred to the plate or pan without lifting the cutting board.

In an embodiment, the cutaway section has a curved edge which is similar in shape to a portion of the circumference of the plate, container or cooking device. The plate, container or cooking device may be placed under the cutaway section so that the outer diameter is just under the curved edge of the cutaway section. The cut food items may then be pushed over the cutaway section so they fall onto the underlying plate, container or cooking device. The inventive cutting board simplifies the transfer of food items because the cutaway section shortens the sliding distance of the food items, provides a large area through which to transfer the cut food and the cutting board may not need to be lifted in order to transfer the cut food.

In some applications, the plate, container or cooking device into which the cut food is to be transferred may not fit in the open space under the cutting board or may not be conveniently moved. For example, it may not be convenient to move a hot cooking device onto a non-heat resistant counter top. In these types of applications, the cut food items are transferred by transporting the inventive cutting board to the plate, container or cooking device.

The inventive cutting board is easily lifted because the cutting surface is elevated and it is easy to place fingers under the cutting surface. The cook's fingers are used to lift the cutting board and the thumb can easily grasp the edge of the cutting surface. It is generally preferable to transport the cutting board by lifting at the center of gravity of the cutting board. For the reasons discussed, a cook can easily position his or her hand under the cutting surface at a position close to the center of gravity which simplifies the lifting and movement of the cutting board.

When the cutting board is moved to a circular container or cooking device, it is desirable to place the curved edge of the cutaway section just inside the edge of the container or cooking device. In an embodiment, the underside of the inventive cutting board close to the cutaway section has a protrusion or indentation which engages the edge of the container or cooking device and simplifies the positioning of the cutting board. By simplifying the positioning the cutaway section of the inventive cutting board on the edge of the container or cooking device, the cook can more easily transfer cut food items.

### BRIEF DESCRIPTION OF THE DRAWINGS

The invention is herein described, by way of example only, with reference to embodiments of the present invention illustrated in the accompanying drawings, wherein:

FIG. 1 illustrates a view of the inventive cutting board;

FIG. 2 illustrates a view of the inventive cutting board with chopped food item and a container;

FIG. 3 illustrates a view of the inventive cutting board with chopped food item being transferred to a container;

FIG. 4, illustrates a top view of an embodiment of the inventive cutting board having a curved edge defined by multiple diameters;

FIG. 5 illustrates a front view of an embodiment of the inventive cutting board having an alignment protrusion;

FIG. 6 illustrates a bottom view of an embodiment of the inventive cutting board having two alignment protrusions;

FIG. 7 illustrates a bottom view of an embodiment of the inventive cutting board having an alignment groove; and

FIG. 8 illustrates a front view of the inventive cutting board.

### DETAILED DESCRIPTION

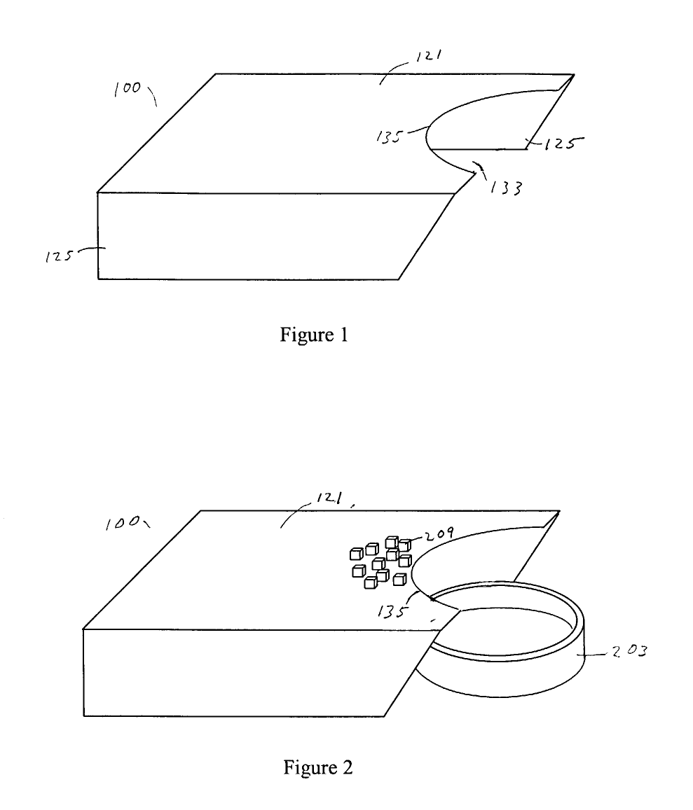

FIG. 1 illustrates an embodiment of the inventive cutting board 100 which has a planar cutting surface 121 which has support members 125 which elevate the cutting surface 121 off of a working surface. The cutting surface 121 has a cut away section 133 and a curved edge 135. The inventive cutting board 100 is used like a conventional cutting board in that the cutting surface 121 of the cutting board is made of a durable material that provides a hard surface upon which food items may be cut. In the preferred embodiment, the cutting surface is made of a strong material which can withstand a substantial abrasive force but will not dull a knife blade, such as a hard wood or plastic.

Food items that are cut on a cutting board are typically transferred to a serving plate, a food processor, a storage container or cookware such as a pot or pan. Most of these containers and cookware devices are circular in shape. The inventive cutting board has several features which simplify and improve the transferring of cut food items. The inventive cutting board has an edge which curves inward and may match the curvature of the container. The inward curvature allows the cutting board to be placed on or just above the edge of the circular container. Chopped food items are slid over the curved edge of the curved edge and fall into the container or cookware.

The elevation of the cutting surface and open space under the cutting board allows plates or pans to be placed under the cutting surface. The plates and pans can be positioned so that the outer edge may be placed under the indented edge of the cutting surface before transferring the cut food items. Because the cutting surface is elevated, the cook does not have to lift the cutting board to position the cutting surface over the plate or other flat cookware. Because the outer edge of the plate or pan may be similar to the shape of the curved edge, the cook can see almost all of the plate or pan while transferring the cut food items.

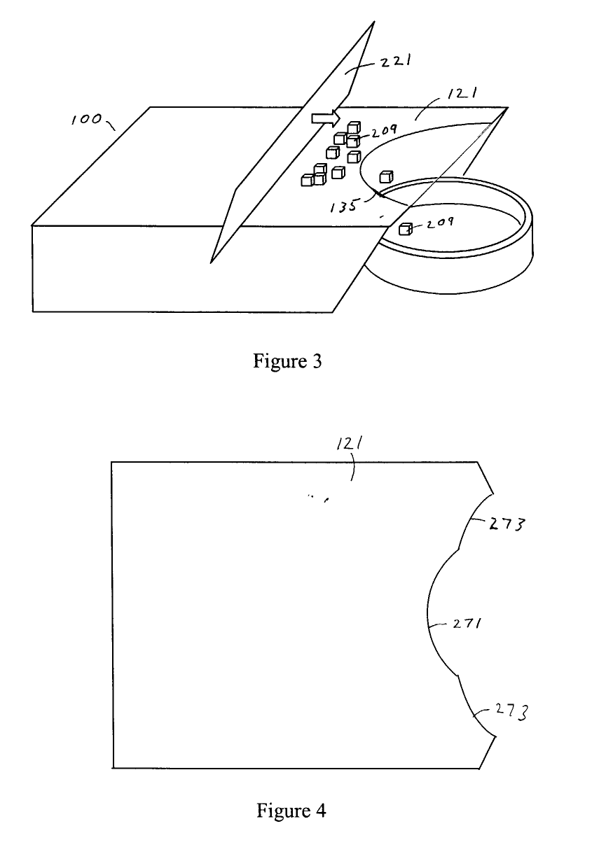

FIG. 2 illustrates a view of the cutting board 100 and a container 203 onto which the cut food items 209 may be transferred. The curvature of the edge of the container 203 is similar to the curvature of the indented edge 135. By placing the edge of the container 203 just under the curved edge 135, the cook does not have to lift the cutting board 100 and can view almost all of the container 203 while transferring the cut food items 209. With reference to FIG. 3, the transfer takes place by sliding the food items 209 over the curved edge 135 of the cutting board 100 with a blade 221, straight edge or by hand. Because the edge of the container 203 is similar in shape to the curved edge 135, the food items 209 will fall from the cutting surface 121 onto the container 203.

The shape of the cutaway section is a matter of personal preference, however as discussed, the cutaway section may have a curved edge which is similar to a section of the outer diameter of a plate, container or cooking device. The circular shape of the plates, containers and cooking devices are commonly made with specific diameter dimensions. For example, dinner plates are commonly made in diameters that are about 10-12 inches in diameter and pans are made in sizes that range from 8 to 14 inches in diameter. In an embodiment, the curved edge may be defined by a diameter.

In order to account for variations in the diameter of plates, containers and cooking devices, the cutaway section of the cutting board may be defined by multiple arcs. For example with reference to FIG. 4, the center section 271 of the curved edge defined by a smaller diameter and the outer sections 273 of the curved edge may be defined by a larger diameter. This embodiment allows the cutting board to be functional with a range of diameters. The cut food items on the cutting surface 121 may be slid over the small diameter center section 271 when transferring to a small diameter plate, container or cooking device. Food items on the cutting surface 121 may be slid over the small center section 271 and the outer section 273 when transferring to a larger diameter plate, container or cooking device.

In many applications, the cutting board 100 must be lifted to transfer cut food items to a container or cooking device. The elevated cutting board 100 allows the cook to easily place his or her hand under cutting surface 121 and lift the cutting board 100 from its center of gravity. Alternatively, the cook can place his or her fingers under the cutting surface 121 close to the center of gravity and grasp the edge of the cutting surface with the thumb. The ability to easily access the bottom of the cutting surface 121 without having to lift the cutting board 100 or without interference from support members 125 simplifies the lifting and transportation of the inventive cutting board 100. Further, because the inventive cutting board 100 is lifted close to its center of gravity, it is easier to carry than a cutting board having a protruding handle. Cutting boards with protruding handles require the user to support the cutting board and food items from a position far from the center of gravity.

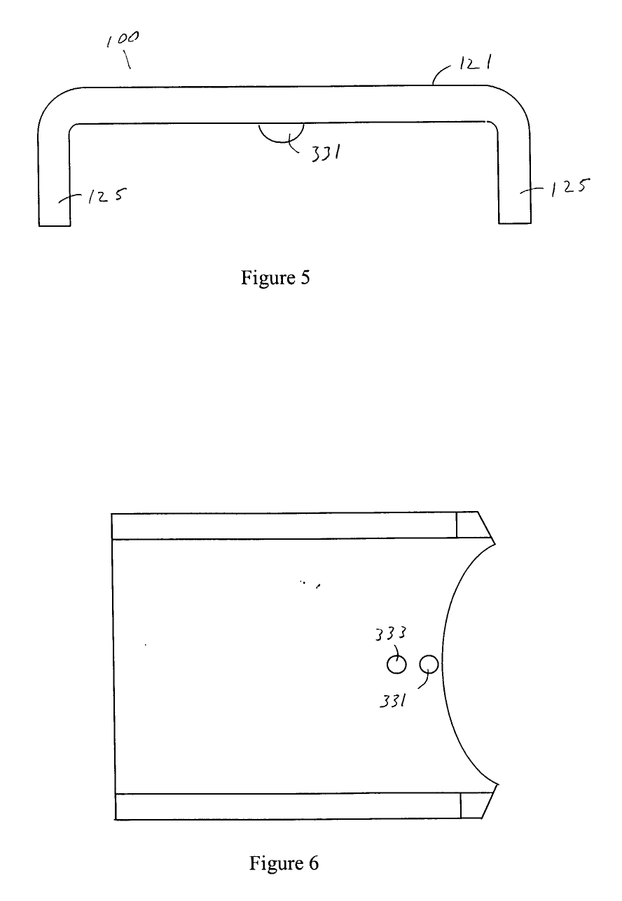

In an embodiment, the inventive cutting board may have a locating device under the cutting surface close to the curved edge which aligns the cutting board with the pot or container. With reference to FIG. 5 in an embodiment, the locating device may be a protrusion 331 under the cutting surface 121 close to the curved edge of the cutaway section. The cutting board 100 may be positioned with the curved section resting on the edge of the container or cooking device. The alignment protrusion 331 may contact the outer or inner edge the container or cooking device to position the curved edge of the cutting board just over the edge of the container or cooking device. When the alignment protrusion 331 is placed on the outer edge, the contact prevents the cutting board from moving towards the container or cooking device when a small force is applied. Conversely, when the alignment protrusion 331 is place on the inner edge, the engagement prevents the cutting board from moving away from the container or cooking device.

With reference to FIG. 6, an embodiment of the inventive cutting board may have two alignment protrusions, one protrusion 331 is located closer to the edge of the curved surface than the second protrusion 333. When properly aligned with the cutting board 100, the first protrusion 331 may contact the outer edge as described above and a second protrusion 333 may engage the inner edge of the container or cooking device. The first protrusion 331 prevents cutting board movement towards the container or cooking device and the second protrusion 333 prevents the cutting board from being moved away from the container or cooking device. The cutting board may need to be lifted to separate it from the container or cooking device.

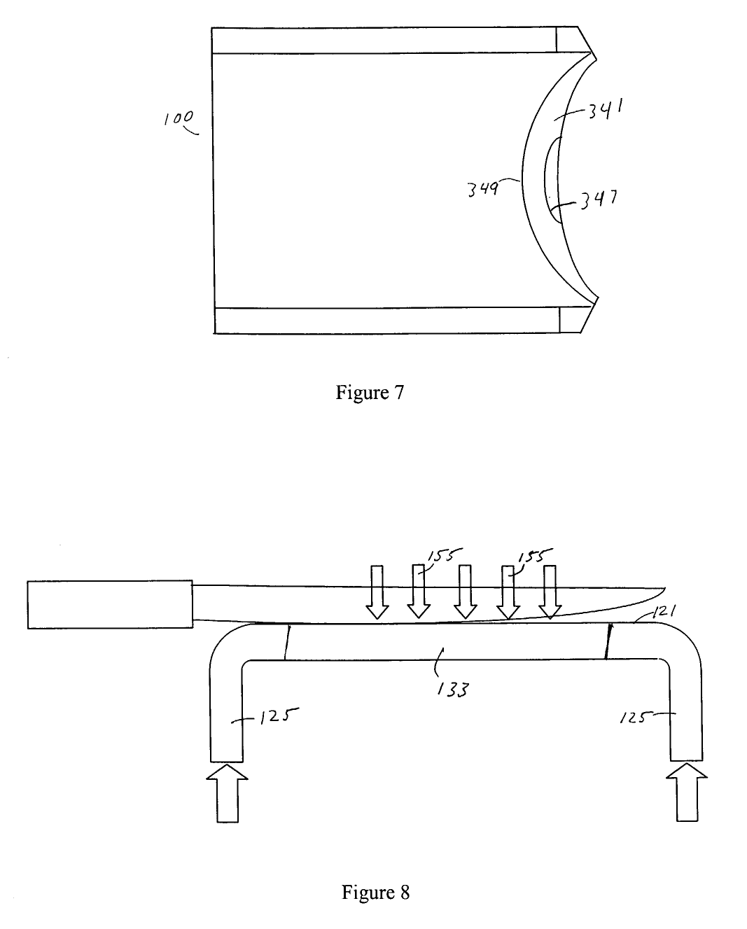

Alternatively, the under side of the cutting surface may have an indentation which engages the edge of the container or cooking device. With reference to FIG. 7, the alignment indentation may be a groove 341 which is similar in shape and can engage the edge of the container or cooking device. Once the groove 341 engages the edge, the cutting board 100 is positioned with the curved edge over the container or cooking device such that the cutting board 100 cannot move towards or away from the container or cooking device without being lifted. In an embodiment, the groove 341 will accommodate the differing range of diameters and shapes offered by the different pots, pans, and cooking devices. The inner edge 347 of the groove 341 may have a sharp curvature and the outer edge 349 may have a more gradual curvature.

With reference to FIG. 8, in the preferred embodiment, the support members 125 are positioned close to the sides of the cutting surface 121 and on either side of the cut away section 133. During the cutting process, a downward force 155 is applied to the cutting surface 121. The downward force 155 should be applied between the support members 125 in order for the cutting board 100 to be stable during the cutting process. The stability of the cutting board 100 is assured by placing the support members 125 at or close to the edges of the cutting surface 121.

If a downward force is not applied between or above the support members, the cutting board may be unstable and be flipped during the cutting process. Movement of the cutting board during the cutting process creates a hazardous situation because unexpected movement of a knife blade can injure people that it comes into contact with. By placing the supports at the periphery of the cutting surface the cutting force is always applied between the supports.

During the cutting process, the cutting process the food item being cut may produce fluids which may drip onto the cutting surface. It may be desirable to collect the fluids. Various means for collecting the fluids may be incorporated into the inventive cutting board independently or in combination. A cup may be formed in the cutting surface to trap the fluids so that after the food items are cut and removed from the cutting board the fluids may be poured out of the cup. Alternatively, a hole or slot may be cut into the cutting surface so that the fluids drip through the hole or slot. In an embodiment the fluid may flow through the hole or slot into a container mounted below the cutting surface. In yet another embodiment, a fluid reservoir may be built into one or both of the supports. The cutting surface may be convex and the fluids may flow over the cutting surface and into the reservoir(s) built into the support(s). A valve may be placed at the bottom of the support reservoir so that the fluids can be drained.

The cutting surface may include certain design features to channel the fluids into the cup, slot, hole or reservoir. Grooves may be formed in the cutting surface to direct the flow of the fluids. The cutting surface may be concave so that the fluids gather at the lowest section of the cutting surface. The supports may be configured so that the cutting surface is tilted towards the cup, slot, hole or reservoir. Again these channeling methods may be used independently or in combination.

The cutting board may be fabricated from various materials. The choice of materials may be based upon the preference of the manufacturer. Suitable materials for the cutting surface include wood and plastic. Because the cutting surface is elevated by supports and a large area of the cutting surface may not be supported, the cutting surface should be a stiff material which will not bend under the normal forces applied during cutting or chopping. In order to make the cutting surface strong and stiff, the wood or plastic cutting surface may be attached to a support layer made of a different material. For example, a metal layer which would not be an ideal cutting surface may be attached to a wood layer which is a suitable cutting surface. The metal layer may be a solid plate or any other type of metal structure which is attached to the cutting surface for added support. A metal plate or structure may be attached to the cutting surface with fasteners such as: screws, nails, bolts, etc or an adhesive such as a glue, epoxy, thermal, etc.

The support members should be made of a strong material such as metal, plastic wood and composites. The supports may be any shape or size which provide the required support for the cutting surface. In the embodiments illustrated the support members run the length of the cutting surface and are solid. Alternatively, a plurality of thinner supports may be mounted under the cutting surface. The bottoms of the support members should be flat so that the cutting board will not damage a working surface.

In some situations, a cook may apply a horizontal force to a knife used to cut a food item. The horizontal motion of the knife produces a horizontal or shear force on the cutting board. In addition to supporting the cutting surface from downward forces, the support members should also be strong enough to support the cutting surface from horizontal forces. In order to prevent the cutting board from sliding across a work surface while cutting the food items, rubber feet may be attached to the bottoms of the support members. The rubber feet protect the working surface from damage and grip the working surface to prevent sliding during cutting. Although only the use of rubber has been discussed above, any other soft material having a high coefficient of friction can be used on the bottoms of the support members.

Various materials and fabrication processes may be used to construct the inventive cutting board. In an embodiment, the inventive cutting board is made of a multi-layer wood laminate. The wood laminate cutting board may be made of 5 layers of 1/16″ hardwood maple veneer with two support legs bending down from the cutting surface. The wood layers are cold-pressed into the required shape by placing the wood laminate in a mold or die under force. The mold bends the wood laminate into the final shape of the cutting board. In an embodiment, the cutting board may be made from 5 layers of 1/16″ maple veneer which were cold-pressed in the mold. Any number of layers may be used and any suitable glue may be used to hold the layers to each other. In alternate embodiments, the cutting board wood laminate includes twelve layers of red oak veneer that are soaked in hot water before bending and glued together with a polyurethane glue, a phenolic resin, urea formaldehyde or any other suitable glue.

In order to strengthen the wood laminate the grain of each layer may be different than the adjacent layer. For example, the grain of each layer of maple may be rotated 90 degrees from the adjacent layer or layers. For aesthetics and structural reasons, the grain of the outer layer may run over the edge of the bend. After gluing the wood laminate layers together, C-clamps may be used to hold the layers together while the glue cures. Pressure may be also be applied to the wood laminate to ensure that the desired laminate cutting board shape is achieved. After the wood laminate glue has cured, a saw may be used to cut the bottom of the support members so they are parallel with the cutting surface.

In an embodiment, the support members are cut back from the outer edge by the cut away section and may be described as a ‘contoured overhang.’ The contoured overhang was cut by using two other jigs and the band saw. In an embodiment, the contoured overhangs as well as the cut away section of the cutting surface may be formed with a saw after the wood laminate is bent into the desired shape.

The alignment protrusion may be formed by drilling a hole was then drilled in the cutting surface. A cylindrical wooden “button” is then inserted into the hole and glued in place. In an embodiment, the alignment protrusion is hemispherical in shape. The top of the plug may be sanded smooth with the exposed cutting surface. The entire cutting board may then be sanded to a desired smoothness and stained with olive oil or mineral oil.

The inventive cutting board may also be fabricated out of various other materials. It is desirable to utilize a wooden or plastic cutting surface, however the support members and cutting surface support layer may be made of different material including: fiberglass, metal and plastic.

Fiberglass support members and cutting surface support layers may be formed by mixing glass or other composite fibers (carbon or aramid fibers) with a resin to form a composite matrix. The resin and fiber mixture may be inserted into form molds and, when the resin hardens, high strength structures are formed. Alternatively, the fibers and resin may be applied over a low density structure such as polyurethane foam, polystyrene foam or balsa wood support members. Again when the resin hardens, high strength support members are formed.

In another embodiment, a cutting board frame is formed with sheet metal. The center of the sheet metal form may function as a cutting surface support. The support members may be formed by bending portions of the sheet metal downward. As discussed, the contact area between the cutting board and the working surface should be large to disperse the downward forces applied during the cutting process. The bottoms of the support members may be formed by again bending the sheet metal to provide a larger contact area. A wooden cutting surface is attached to the metal cutting surface support area.

In another embodiment, the inventive cutting board is fabricated from polyethylene plastic such as Sani-Lite made by Poly Hi Solidur. The cutting board shape may be formed by router cutting from a solid sheet of polyethylene following a template clamped to the polyethylene or by attaching the polyethylene to a jig and milling the material in a CNC machine. The Sani-Lite material is made for food prep and is USDA approved. In this embodiment, the support members may be fabricated and mechanically fastened or welded to the cutting surface.

In other embodiments, the support members and cutting board support layer are made by molding or bending acrylic, reaction injection molding with resins with fiber, reaction injection molding with wood is placed in the mold, injection molded plastic, blow molding, extrusion molding or any other fabrication method that forms the inventive structure.

In the foregoing, a cutting board invention has been described. Although the present invention has been described with reference to specific exemplary embodiments including the order filling system, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A cutting board comprising:
a cutting surface having an indented edge; and
a plurality of support members for elevating the cutting surface;
wherein an open space exists under the indented edge.

2. The cutting board of claim 1, wherein the cutting surface includes a cup for collecting a fluid.

3. The cutting board of claim 1, further comprising a protrusion on the underside of the cutting surface proximate the indented edge for positioning the cutting board on an edge of a container.

4. The cutting board of claim 1, wherein the support members elevate the cutting surface is at least 3 inches.

5. The cutting board of claim 1, wherein the substantially rectangular open space is at least 10 inches in width.

6. The cutting board of claim 1 wherein a metal plate is mounted under the cutting surface for structurally support.

7. The cutting board of claim 1, wherein the cutting surface has two substantially parallel edges adjacent to the indented edge and some of the plurality of supports are mounted proximate the substantially parallel edges.

8. A cutting board comprising:
a cutting surface having a concave edge; and
a plurality of support members for elevating the cutting surface;
wherein in open area exists under the cutting surface.

9. The cutting board of claim 8, wherein the cutting surface has a concave section for channeling a fluid.

10. The cutting board of claim 8, wherein the cutting surface has a convex section.

11. The cutting board of claim 8, wherein a portion of the concave edge is defined by a radius.

11. The cutting board of claim 8, wherein a portion of the concave edge is elliptical.

12. The cutting board of claim 8, wherein the open area under the cutting surface extends from the concave edge to the opposite side of the cutting board.

13. The cutting board of claim 8, wherein two edges of the cutting surface on opposite sides of the concave edge curve downward to form the two supports.

14. The cutting board of claim 8 further comprising:
friction pads mounted under the plurality of supports to prevent the cutting board from sliding during use.

15. The cutting board of claim 8, further comprising:
an alignment indentation on the underside of cutting surface proximate the concave edge.

16. A method for transferring cut food items into a container comprising the following steps:
providing a cutting board having a cutting surface with an concave edge and supports which elevate the cutting surface off of a working surface;
placing food items on the cutting surface;
cutting the food items;
positioning an edge of a plate, a container or a cooking device having a circular shape under the curved edge of the cutting surface; and
transferring the cut food items from the cutting board to the container by sliding the cut food items over the concave edge of the cutting surface.

17. The method for transferring cut food items of claim 16 further comprising the step:
placing a protrusion extending from under the cutting surface of the cutting board against an edge of the container.

18. The method for transferring cut food items of claim 16 further comprising the step:
moving the container during the transferring step to disperse the food items over the container.

19. The method for transferring cut food items of claim 16 further comprising the step:
collecting a fluid from the cut food items in a fluid collection indentation in the cutting surface.

20. The method for transferring cut food items of claim 16 further comprising the step:
grasping the cutting surface at a position opposite the convex side; and
lifting the cutting board;
wherein during the positioning step includes placing the curved edge of the cutting board on the edge of the plate, the container or the cooking device.
